(19) United States
(12) Patent Application Publication
(10) Pub. No.: US 2025/0245948 A1
(43) Pub. Date: Jul. 31, 2025

(54) METHODS, SYSTEMS, AND APPARATUSES FOR GENERATING CUSTOM MESHES TO RENDER CONTENT DURING CONFLICT OCCURRENCES

(71) Applicant: Apple Inc., Cupertino, CA (US)

(72) Inventors: Matheus de Almeida Aguiar Candido, Guildford (GB); Shruti Singhal, Campbell, CA (US); Caleb R Biasco, Sunnyvale, CA (US)

(21) Appl. No.: 19/021,835

(22) Filed: Jan. 15, 2025

Related U.S. Application Data
(60) Provisional application No. 63/626,302, filed on Jan. 29, 2024.

(51) Int. Cl. G06T 19/20; G06T 7/13

(52) U.S. Cl. CPC G06T 19/20; G06T 7/13; G06T 2219/2024

(57) ABSTRACT

Various implementations disclosed herein include methods, systems, and apparatuses that determine a first set of vertices, such as corners, associated with edges of a content item, determine a second set of vertices offset from the first set of vertices, wherein the offset is determined based on a distance, determine a boundary around the content item including all of the second set of vertices, and apply a transitional effect, which may be a gradually transparent gradient, between the boundary and the edges of the content item.

### CROSS-REFERENCE TO RELATED APPLICATIONS

This application claims the benefit of U.S. Provisional Application Ser. No. 63/626,302 filed Jan. 29, 2024, which is incorporated herein in its entirety.

### TECHNICAL FIELD

The present disclosure generally relates to methods, systems, and apparatuses for generating custom meshes to render content during conflict occurrences.

### BACKGROUND

Various techniques are used to render digital content. In some examples, multiple different digital content is rendered on a display. In view of the limited screen space associated with a display, it is common for one digital content to overlap or otherwise occlude another digital content. In three-dimensions, digital content may also intersect or come into close proximity to another digital content. Such conflict occurrences may cause unpleasant user interactions. Current mesh generation techniques either allow overlap or choose not to render one content item during a conflict occurrence.

### SUMMARY

Various implementations disclosed herein include methods, systems, and apparatuses for rendering content during one or more conflict occurrences. An example method may comprise determining a first set of vertices associated with edges of a content item (e.g., four corners of a quadrilateral), determining a second set of vertices offset (externally) from the first set of vertices, wherein the offset is determined based on a distance (e.g., a percentage of a height or width of the content item), determining a boundary around the content item including all of the second set of vertices, and applying a transitional (e.g., a gradient of transparency) effect between the boundary and the edges of the content item.

An example system may comprise one or more processors and memory storing instructions that, when executed by the one or more processors, cause determining a first set of vertices associated with edges of a content item, determining a second set of vertices offset from the first set of vertices, wherein the offset is determined based on a distance, determining a boundary around the content item including all of the second set of vertices, and applying a transitional effect between the boundary and the edges of the content item.

An example (e.g., non-transitory) computer readable storage medium may store instructions that, when executed, cause determining a first set of vertices associated with edges of a content item, determining a second set of vertices offset from the first set of vertices, wherein the offset is determined based on a distance, determining a boundary around the content item including all of the second set of vertices, and applying a transitional effect between the boundary and the edges of the content item.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1D illustrate various examples of content conflict occurrences in accordance with one or more aspects of the present disclosure.

FIGS. 2A-2D illustrate various transitional effects caused by the example rendering methods, systems, and apparatuses disclosed herein, which mitigate content conflict occurrences in accordance with one or more aspects of the present disclosure.

FIGS. 3A-3B illustrate block diagrams for determining mesh vertices for creating various transitional effects for planar content at a first perspective in accordance with one or more aspects of the present disclosure.

FIG. 4 illustrates a block diagram for determining additional mesh vertices for creating various transitional effects for planar content at the first perspective in accordance with one or more aspects of the present disclosure.

FIGS. 5A-5B illustrate block diagrams for determining mesh vertices for creating various transitional effects for planar content at a second perspective in accordance with one or more aspects of the present disclosure.

FIG. 6 illustrates a block diagram for determining additional mesh vertices for creating various transitional effects for planar content at the second perspective in accordance with one or more aspects of the present disclosure.

FIG. 7 illustrates a block diagram for determining mesh vertices for creating various transitional effects for non-planar content in accordance with one or more aspects of the present disclosure.

FIG. 8 illustrates a flow chart depicting an example computer executable process for mitigating content conflict occurrences in accordance with one or more aspects of the present disclosure.

FIG. 9 illustrates a block diagram of an example device in accordance with one or more aspects of the present disclosure.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

The example methods, systems, and apparatuses disclosed herein relate to generating custom meshes to render content during conflict occurrences in a three-dimensional (3D) extended reality (XR) environment. In some examples, a handheld electronic device (e.g., a smartphone or a tablet) or a near-eye device such as a head worn device (e.g., a head mounted device (HMD)) may utilize one or more display elements to present views of multi-dimensional content to a user, in which content items may be rendered. In some examples, one or more devices may be used to present views of multi-dimensional content to a user, in which content items may be rendered. In some examples, the one or more devices may communicate with a separate controller or server to manage and coordinate an experience for the user. Such a controller or server may be located in or may be remote relative to the physical environment.

The physical environment may be a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment may be a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There may be many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some examples, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In some examples, one or more digital content items (e.g., media) may be presented on a single display device (e.g., a screen), or presented on one or more display devices that collectively provide a single display experience (e.g., one screen for each eye to create a stereoscopic experience). In each case, as more digital content is simultaneously displayed, less screen space becomes available for non-conflicting display of additional digital content.

In some examples, digital content items are associated with occluders. Occluders may be a mesh or visual effect that may be used for rendering; intersection determinations, overlap determinations, and occlusion tests (e.g., based on axis-aligned bounding boxes); world transforms; and/or any combination thereof. In some examples, occluders are the smallest axis-aligned cuboid that can completely contain a content item.

Eventually, one of more digital content item(s) may conflict with one or more other digital content item(s). For example, the digital content may overlap, occlude, intersect, interfere, obscure, or otherwise cause errors with other digital content. In some examples, such conflicts may be based on respective occluders associated with the content items (e.g., detecting that one or more occluders associated with the content items overlap, occlude, intersect, interfere, obscure, etc.). In some examples, such conflict occurrences may be determined before the content is rendered. In some such examples, one or more digital content may be hidden (e.g., according to a priority determination) to avoid erroneous rendering. In some examples, conflicting content may be rendered and presented to a user. In some such examples, what is rendered may not be what was intended due to one or more conflict occurrences.

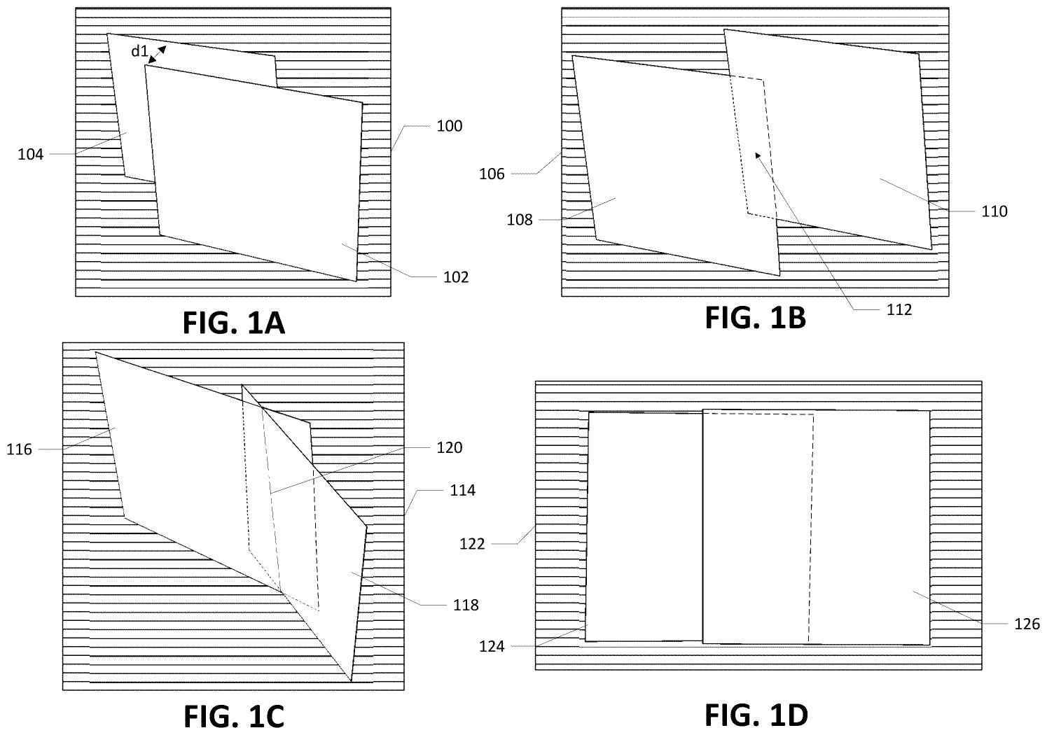

FIGS. 1A-1D illustrate example scenarios in which content may interact in digital environment. While the examples illustrated in FIGS. 1A-1D are presented in a three-dimensional (3D) environment, such scenarios may equally apply to two-dimensional (2D) environments. FIG. 1A illustrates a first environment 100 comprising a first content item 102 and a second content item 104. As illustrated in FIG. 1A, the first content item 102 may be separated from the second content item 104 by a distance d1. In some examples, the distance d1 may be greater than a threshold distance, which may ensure no conflict occurrences exist or are likely to exist. In some such examples, the first content item 102 and the second content item 104 may be rendered normally according to well known techniques (e.g., hidden-surface determination).

FIG. 1B illustrates a second environment 106 comprising a third content item 108 and a fourth content item 110. In the illustrated example of FIG. 1B, the third content item 108 and the fourth content item 110 may share one or more coordinates in a portion 112 such that a conflict exists regarding which content item should be rendered in the portion 112. In some examples, the portion 112 may be a collection of coordinates within a geometric plane. In some such examples, neither the third content item 108 nor the fourth content item 110 is in front of, behind, or otherwise overlapping the other. In some such examples, existing techniques such as depth or z buffering, which reject pixels “behind” other pixels (e.g., based on a depth value), may be ineffective.

FIG. 1C illustrates a third environment 114 comprising a fifth content item 116 and a sixth content item 118. In the illustrated example of FIG. 1C, the fifth content item 116 and the sixth content item 118 may share one or more coordinates along a line 120 (e.g., due to the fifth content item 116 intersecting with the sixth content item 118), such that a conflict exists regarding how each content item should be rendered. Indeed, in the illustrated example of FIG. 1C, the fifth content item 116 is both in front of and behind the sixth content item 118, and the sixth content item 118 is both in front of and behind the fifth content item 116. In some such examples, existing techniques may result in merging portions of the fifth content item 116 and the sixth content item 118 (e.g., the respective portions of each content item that is in front of the other content item), while not rendering other portions of the fifth content item 116 and the sixth content item 118 (e.g., the respective portions of each content item that is behind the other content item).

FIG. 1D illustrates a fourth environment 122 comprising a seventh content item 124 and an eighth content item 126. As illustrated in FIG. 1D, the eighth content item 126 may overlap the seventh content item 124. In some examples, the distance between the eighth content item 126 and the seventh content item 124 may be lower than the threshold distance described with respect to FIG. 1A, such that a conflict may not currently exist but may be likely (e.g., based on movement or anticipated movement of the content items towards each other).

As illustrated in FIGS. 1A-1D, the exemplary scenarios may result in one or more conflict occurrences between content items. The exemplary methods, systems, and apparatuses disclosed herein mitigate such conflict occurrences during the rendering process to avoid erroneous content rendering which would disrupt, ruin, or otherwise make unpleasant viewing of rendered content. For example, the methods, systems, and apparatuses disclosed herein create a transitional effect around a content item when that content item is or will conflict with another content item. The transitional effect may comprise a gradually (e.g., gradient) transparent border around the content item that emphasizes the content item, while de-emphasizing the conflicting content item.

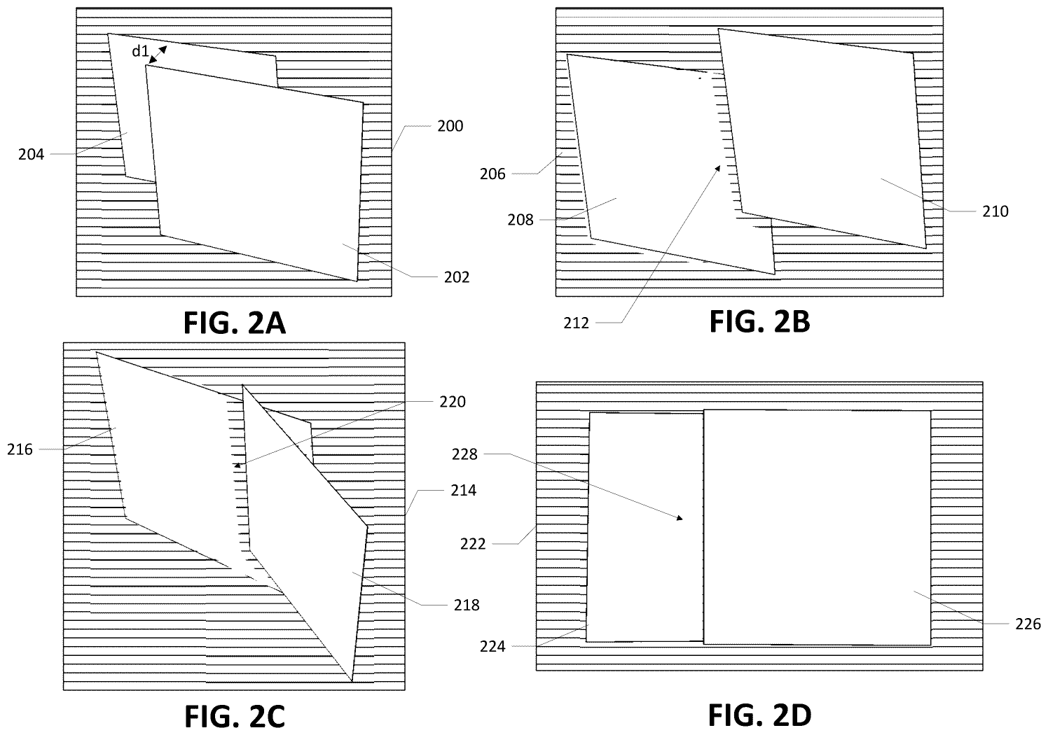

FIGS. 2A-2D illustrate such mitigation in similar example scenarios as described in FIGS. 1A-1D. For example, FIG. 2A illustrates a first environment 200 comprising a first content item 202 and a second content item 204. As illustrated in FIG. 2A, the first content item 202 may be separated from the second content item 204 by a distance d1, such that conflict mitigation may not occur. However, FIG. 2B illustrates a scenario where mitigation may occur. As shown in FIG. 2B, a second environment 206 may comprise a third content item 208 and a fourth content item 210 within the same geometric plane. In the illustrated example of FIG. 2B, the third content item 208 and the fourth content item 210 would otherwise conflict as illustrated with respect to FIG. 1B. But, the methods, systems, and apparatuses described herein may generate a transitional effect 212, which may extend outwardly from the fourth content item 210 to ensure rendering of the fourth content item 210 and mitigate conflicts with the third content item 208.

The transitional effect 212 may be a border surrounding the fourth content item 210. In some examples, the transitional effect 212 may be two-dimensional (e.g., surrounding the left, right, top, and bottom sides of the fourth content item 210), such as in the illustrated example of FIG. 2B where the third content item 208 and the fourth content item 210 are within the same plane. In some examples, the transitional effect 212 may be enabled based on a determination that the fourth content item 210 will conflict with or is conflicting with another content item (e.g., the third content item 208). In some examples, while the transitional effect 212 may surround the fourth content item 210, the transitional effect 212 may be applied to other content items which would otherwise conflict with the fourth content item 210. For example, the transitional effect 212 may be applied to portions of the third content item 208.

In some examples, the transitional effect 212 may be a gradual transparent border that may enable a view of the second environment 206 to be seen (which would otherwise be blocked by the third content item 208) and which may disable a portion of conflicting content (e.g., the third content item 208) from being seen. In some examples, the transitional effect 212 may extend a distance from the fourth content item 210. In some examples, the transitional effect 212 may be fully transparent (e.g., the second environment 206 may be seen completely) adjacent the edges of the fourth content item 210. In some examples, the transitional effect 212 may gradually decrease transparency as distance increases away from the fourth content item 210 (e.g., less and less of the second environment 206 may be seen as the distance increases). In some examples, the transparency may be a result of a gradient effect. In some examples, the transparency may vary according to a (2D quadratic, 2D cubic, etc.) Bezier curve. In some examples, as the distance increases away from the fourth content item 210, more and more of conflicting content (e.g., the third content item 208) may be seen. In some examples, the transitional effect 212 may lose transparency at the distance, and any other content items at the distance (e.g., the third content item 208) may be visible.

In some examples, the transitional effect 212 may be consistent around a content item (e.g., where the content item is symmetrical and/or viewed from a head-on perspective). In some examples, the transitional effect 212 may differ near corners of a content item compared with the sides of a content item (e.g., where the content item is not symmetrical and/or viewed from a perspective that distorts the shape of the content item). For example, while the sides of a content item may be associated with a first translational effect (e.g., a first transparent gradient), each corner of a content item may be associated with a different (e.g., more or less substantial transparent gradient) translational effect, depending on the angles associated with that corner. In some examples, the transparency may be configurable by a user. In some such examples, the transitional effect 212 provides a transparent buffer around the fourth content item 210 that gradually fades portions of the third content item 208 near the fourth content item 210 and enables viewing of the second environment 206 therethrough.

In some examples, the transitional effect 212 may be reversed, such that the transparent effect may vary as distance decreases towards the content item, rather than as distance increases away from the content item.

In some examples, the distance that the transitional effect 212 extends around the fourth content item 210 may be constant. Alternatively, the transitional effect 212 may be larger in one dimension (e.g., an X dimension) than another dimension (e.g., a Y dimension). In some examples, the transitional effect 212 may have a constant size with respect to screen space (e.g., a same pixel width/number of pixels regardless of zoom/orientation). In some examples, the distance may be a function of a dimension of the fourth content item 210. For example, the distance may be correlated to a distance from a center of the fourth content item 210 to an edge of the fourth content item 210. In some examples, the distance may be equal to (e.g., 100%) or a fraction of (e.g., <100%) that length. In some examples, the distance may be a function of multiple dimensions of the fourth content item 210. For example, the distance may be the minimum distance of a first dimension (e.g., a width), a second dimension (e.g., a height), and/or a third dimension (e.g., a length). As another example, the distance may be the average distance of the first dimension, the second dimension, and/or the third dimension. As another example, the distance may be determined according to one or more equations taking multiple dimensions into account such as, for example, the radius of an ellipsoid:

$$r ( θ ) = \frac{ab}{\sqrt{{( b cos θ )}^{2} + {( a sin θ )}^{2}}} ,$$

where a is the length of the horizontal semi-axis, b is the length of the vertical semi-axis, and θ is the angle between r and the horizontal axis; or the hypotenuse of a triangle: c=\sqrt{a²+b²}, where a is the length of a first leg and b is the length of a second leg.

FIG. 2C illustrates a third environment 214 comprising a fifth content item 216 and a sixth content item 218. In the illustrated example of FIG. 2C, the fifth content item 216 and the sixth content item 218 would otherwise conflict as illustrated with respect to FIG. 1C. But, the methods, systems, and apparatuses described herein may generate a transitional effect 220 (similar to the transitional effect 212 described with respect to FIG. 2B). In the illustrated example of FIG. 2C, the fifth content item 216 and the sixth content item 218 are not within a same plane, but rather in different planes within a three-dimensional view of the third environment 214 (except for the points of intersection). Accordingly, the transitional effect 220 may surround the sixth content item 218 in three dimensions, as appropriate. For example, the transitional effect 220 may surround the left and right sides of the sixth content item 218 (first dimension), surround the top and bottom sides of the sixth content item 218 (second dimension), and be in front of and behind the sixth content item 218 (third dimension). In doing so, the transitional effect 220 provides a transparent buffer around the sixth content item 218 that gradually fades portions of the fifth content item 216 near the sixth content item 218 and enables viewing of the third environment 214 therethrough.

FIG. 2D illustrates a fourth environment 222 comprising a seventh content item 224 and an eighth content item 226. As illustrated in FIG. 2D, the eighth content item 226 may overlap the seventh content item 224. In some examples, the distance between the eighth content item 226 and the seventh content item 224 may be lower than the threshold distance described with respect to FIG. 2A, such that a conflict may not currently exist but may be likely (e.g., based on movement or anticipated movement of the content items towards each other). In some such examples where the distance between the eighth content item 226 and the seventh content item 224 is lower than the threshold distance, the methods, systems, and apparatuses described herein may generate a transitional effect 228 (similar to the transitional effect 212 described with respect to FIG. 2B and the transitional effect 220 described with respect to FIG. 2C) due to the proximity of the eighth content item 226 and the seventh content item 224. In some examples, a user

In some examples, the transitional effect 228 may provide a transparent buffer around the eighth content item 226 that gradually fades portions of the seventh content item 224 near the eighth content item 226 and enables viewing of the fourth environment 222 therethrough. In some examples, the transitional effect 228 may be amplified as the distance between the eighth content item 226 and the seventh content item 224 decreases. In some examples, the transitional effect 228 may be reduced as the distance between the eighth content item 226 and the seventh content item 224 increases. In some examples, the transitional effect 228 may be removed completely when the distance between the eighth content item 226 and the seventh content item 224 becomes greater than the threshold distance.

In some examples, the transitional effects described herein may be triggered based on intersection detection (e.g., determining a shared line within infinite planes, and testing if finite planes share a point on that line), occlusion detection (e.g., determining screen-space overlap, determining shared point on screen-space, un-projecting determined screen-space shared point into world-space, ray-plane intersection from camera to shared point on plane and checking which plane was hit first), and/or proximity detection (e.g., detecting that portions of one or more content items are within a threshold distance from each other either in screen space (2D) or world space (3D)). Additionally, which content item that the transitional effects described herein may surround may be determined based on a user's current focus and/or selection. For example, a user's gaze at, and/or a user's selection of, a content item can prioritize that content item for application of the transitional effects described herein.

Although it is described herein that the transitional effect is being applied to one or more content items (e.g., surrounds those one or more content items), the transitional effect affects other adjacent content items (e.g., making the other adjacent content items semi-transparent/semi-translucent). For example, a first transitional effect may be applied to a first content item, which may affect a second content item (e.g., making one or more portions of the second content item semi-transparent/semi-translucent), and a second transitional effect may be applied to a third content item, which may affect a fourth content item (e.g., making one or more portions of the fourth content item semi-transparent/semi-translucent). As another example, a first transitional effect may be applied to a first content item, which may affect a second content item and a third content item (e.g., making one or more portions of the second content item and one or more portions of the third content item semi-transparent/semi-translucent), and a second transitional effect may be applied to the third content item, which may affect a fourth content item (e.g., making one or more portions of the fourth content item semi-transparent/semi-translucent).

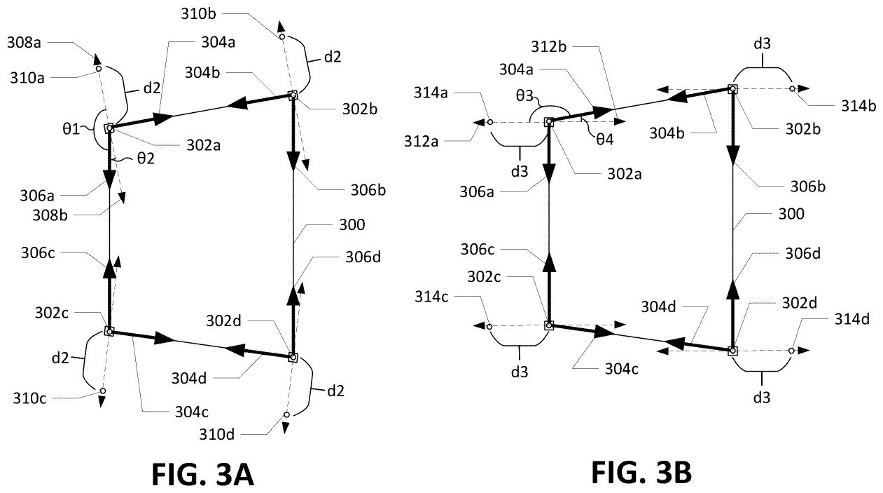

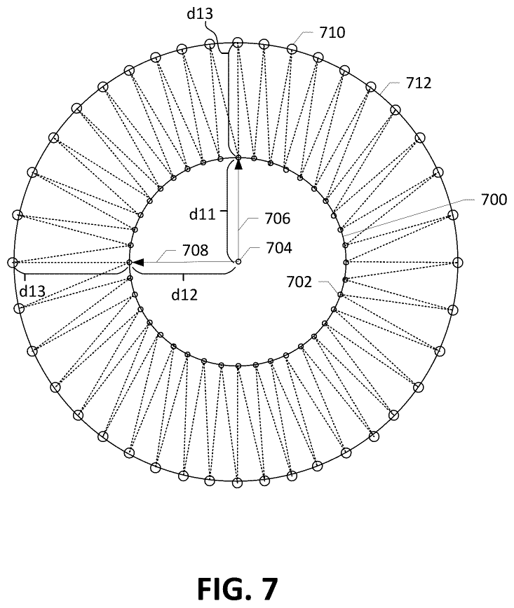

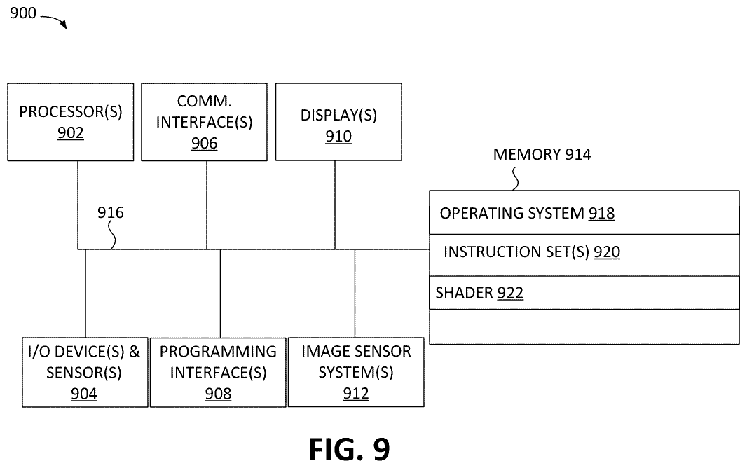

Turning now to FIGS. 3A-6, one or more procedures for developing the transitional effects for a content item described herein may be detailed. Because content items may be any shape (either 2D or 3D), two exemplary procedures are described below: one for planar (e.g., 2D) content (e.g., FIGS. 3A-6), and one for non-planar (e.g., 3D) content (e.g., FIG. 7). In order to determine whether a content item is planar or non-planar, a shader (e.g., shader 922 of FIG. 9) may analyze the content item dimensions. For example, the shader may determine a content item is planar based on determining that one dimension of the content item is significantly smaller than the other dimensions. In some examples, the shader may determine a content item is planar based on determining whether a smallest dimension is less or equal to a threshold distance (e.g., 1 centimeter). In some examples, the shader may determine a content item is planar based on determining whether a ratio of a largest dimension to a smallest dimension is smaller than a threshold percentage (e.g., 16%). In some examples, the shader may determine that all other content is non-planar.

Even within the context of planar v. non-planar content, content items may vary in shape and size. In some examples, the shader may approximate all planar content to be a quadrilateral. In some examples, the approximated quadrilateral may be the smallest quadrilateral that fully encloses the content item. In some examples, the shader may approximate all non-planar content to be an ellipsoid. In some examples, the approximated ellipsoid may be the smallest ellipsoid that fully encloses the content item.

As shown in FIGS. 3A-3B, a planar content item 300 is illustrated. In the illustrated example of FIG. 3A, the content item 300 may be rectangular, but may represented as a trapezoidal shape when viewed from the 3D perspective illustrated in FIGS. 3A-3B and represented in two-dimensions. In order to generate the transitional effects described herein, the shader may determine a mesh (e.g., 2D mesh) associated with the content item 300. In some examples, the shader may be a 3D shader. The mesh may comprise one or more vertices associated with the content item 300 and one or more vertices offset externally from the one or more vertices associated with the content item 300. In some examples, the one or more offset vertices may form a boundary of the transitional effects described herein.

In some examples, the meshes and vertices that make up the meshes described herein may be determined within projected space (e.g., normalized device coordinates). In some examples, the meshes and corresponding vertices may be converted from world space into projected space. In some such examples, the conversion may comprise perspective projection. In some examples, the processes described herein may be based on a particular device screen aspect ration. In some examples, the processes described herein may involve calculations and determinations within projected space, which may be subsequently converted into world space. In some such examples, the conversion may comprise un-projecting vertices from projected space into world space.

In some examples, the content item 300 may be manipulated in 3D space and/or viewed from a different perspective (e.g., based on a user with a head-mounted device changing his or her location and/or viewpoint). In some examples, when the content item 300 is manipulated and/or viewed from a different perspective, the shader may update the mesh and/or determine a new mesh in accordance with the methodologies described herein. In some examples, despite content manipulations and/or perspective changes, the transitional effects may maintain a constant size or thickness.

In some examples, the shader may determine the mesh by first determining a first set of vertices. In some examples, the first set of vertices may include a first vertex 302a, a second vertex 302b, a third vertex 302c, and a fourth vertex 302d. In some examples, the first vertex 302a, the second vertex 302b, the third vertex 302c, and the fourth vertex 302d may be associated with corners of the content item 300. In some examples, the first vertex 302a, the second vertex 302b, the third vertex 302c, and the fourth vertex 302d may be associated with corners of the smallest approximated quadrilateral that fully encloses the content item 300. In some examples, the first vertex 302a, the second vertex 302b, the third vertex 302c, and the fourth vertex 302d may be associated with corners of an occluder mesh associated with the content item. For each of the first vertex 302a, the second vertex 302b, the third vertex 302c, and the fourth vertex 302d, the shader may determine one or more tangent vectors along one side of the content item 300 and one or more bi-tangent vectors along another side of the content item 300.

For example, the shader may determine a first tangent vector 304a starting at the first vertex 302a and extending along a top side of the content item 300. In some examples, the shader may determine a first bi-tangent vector 306a starting at the first vertex 302a and extending along a left side of the content item 300. In some examples, the shader may determine a second tangent vector 304b starting at the second vertex 302b and extending along the top side of the content item 300. In some examples, the shader may determine a second bi-tangent vector 306b starting at the second vertex 302b and extending along a right side of the content item 300. In some examples, the shader may determine a third tangent vector 304c starting at the third vertex 302c and extending along the bottom side of the content item 300. In some examples, the shader may determine a third bi-tangent vector 306c starting at the third vertex 302c and extending along the left side of the content item 300. In some examples, the shader may determine a fourth tangent vector 304d starting at the fourth vertex 302d and extending along the bottom side of the content item 300. In some examples, the shader may determine a fourth bi-tangent vector 306d starting at the fourth vertex 302d and extending along the right side of the content item 300.

As illustrated in FIG. 3A, the first tangent vector 304a and the second tangent vector 304b; the third tangent vector 304c and the fourth tangent vector 304d; the first bi-tangent vector 306a and the third bi-tangent vector 306c; and the second bi-tangent vector 306b and the fourth bi-tangent vector 306d may be directed towards each other and towards a center line of the content item 300.

For each tangent vector, the shader may determine one or more associated normal vectors. For example, for the first tangent vector 304a, the shader may determine a first normal vector 308a and a second normal vector 308b. In some examples, the first normal vector 308a and the second normal vector 308b may be within the same plane as the content item 300. In some examples, the first normal vector 308a may be a vector rotated 90 degrees counterclockwise from the first tangent vector 304a around the first vertex 302a (or away from a center of the content item 300). In some examples, the second normal vector 308b may be a vector rotated 90 degrees clockwise from the first tangent vector 304a around the first vertex 302a (or towards a center of the content item). In some examples, the rotation direction (e.g., clockwise or counterclockwise) may be dependent on the location of the center of the content item with respect to the tangent or bi-tangent vector for which the shader is determining the normal vectors.

In some examples, the shader is configured to determine which normal vector of the first normal vector 308a and the second normal vector 308b is directed outwardly away from the content item 300. In some examples, the shader may determine which normal vector of the first normal vector 308a and the second normal vector 308b is furthest from an adjacent bi-tangent vector (e.g., an adjacent bi-tangent vector that shares a vertex with the tangent vector upon which the normal vectors are based). For example, the shader may determine which normal vector of the first normal vector 308a and the second normal vector 308b is furthest from the first bi-tangent vector 306a (which starts from the first vertex 302a as does the first tangent vector 304a upon with the first normal vector 308a and the second normal vector 308b are based). In some examples, the shader may determine a first angle θ1 from the first normal vector 308a to the first bi-tangent vector 306a. In some examples, the shader may determine a second angle θ2 from the second normal vector 308b to the first bi-tangent vector 306a. In some examples, the shader may compare the first angle θ1 to the second angle θ2 to determine which angle is larger. In some examples, the shader may determine which of the first angle θ1 or the second angle θ2 is an obtuse angle (e.g., greater than 90 degrees). Based on determining which angle is larger or is the obtuse angle, the shader may determine that the corresponding normal vector associated with the larger angle is directed outwardly away from the content item. In the illustrated example of FIG. 3A, the first angle θ1 is larger than the second angle θ2 (and the first angle θ1 is an obtuse angle while the second angle θ2 is an acute angle). Upon determining that the first angle θ1 is larger than the second angle θ2 (or that the first angle is obtuse θ1), the shader may determine that the first normal vector 308a (e.g., the vector associated with the first angle θ1) is directed outwardly away from the content item 300.

The shader may determine a first offset vertex 310a by determining a point on the first normal vector 308a that is offset from the first vertex 302a by a distance d2. In some examples, the distance d2 may correspond to one or more dimensions of the content item 300. For example, the distance d2 may be equal to a length or a height of the content item 300. In some examples, the distance d2 may be a function of (e.g., an equation based on) or proportionate to (e.g., 0-100% of) one or more dimensions of the content item 300. In some examples, the distance d2 may be based on a pre-determined amount of screen-space pixels (e.g., distance d2 may constant in screen-space, regardless of how small or big content item 300 may be on the screen). In some examples, the distance d2 may be configurable by a user. The shader may perform a similar process for each of the second tangent vector 304b, the third tangent vector 304c, and the fourth tangent vector 304d, as shown in FIG. 3A, to determine a second offset vertex 310b, a third offset vertex 310c, and a fourth offset vertex 310d, respectively.

A similar methodology may be performed by the shader with respect to the bi-tangent vectors. As similarly described above with reference to FIG. 3A, the shader may determine, for each bi-tangent vector, one or more associated normal vectors as shown and described with reference to FIG. 3B. For example, for the first bi-tangent vector 306a, the shader may determine a third normal vector 312a and a fourth normal vector 312b. In some examples, the third normal vector 312a and the fourth normal vector 312b may be within the same plane as the content item 300. In some examples, the third normal vector 312a may be a vector rotated 90 degrees clockwise from the first bi-tangent vector 306a around the first vertex 302a (or away from a center of the content item 300). In some examples, the fourth normal vector 312b may be a vector rotated 90 degrees counter clockwise from the first bi-tangent vector 306a around the first vertex 302a (or towards a center of the content item).

In some examples, the shader is configured to determine which normal vector of the third normal vector 312a and the fourth normal vector 312b is directed outwardly away from the content item 300. In some examples, the shader may determine which normal vector of the third normal vector 312a and the fourth normal vector 312b is furthest from an adjacent tangent vector (e.g., an adjacent tangent vector that shares a vertex with the bi-tangent vector upon which the normal vectors are based). For example, the shader may determine which normal vector of the third normal vector 312a and the fourth normal vector 312b is furthest from the first tangent vector 304a (which starts from the first vertex 302a as does the first bi-tangent vector 306a upon with the third normal vector 312a and the fourth normal vector 312b are based). In some examples, the shader may determine a third angle θ3 from the third normal vector 312a to the first tangent vector 304a. In some examples, the shader may determine a fourth angle θ4 from the fourth normal vector 312b to the first tangent vector 304a. In some examples, the shader may compare the third angle θ3 to the fourth angle θ4 to determine which angle is larger. In some examples, the shader may determine which of the third angle θ3 or the fourth angle θ4 is an obtuse angle (e.g., greater than 90 degrees). Based on determining which angle is larger or is the obtuse angle, the shader may determine that the corresponding normal vector associated with the larger angle is directed outwardly away from the content item. In the illustrated example of FIG. 3B, the third angle θ3 is larger than the fourth angle θ4 (and the third angle θ3 is an obtuse angle while the fourth angle θ4 is an acute angle). Upon determining that the third angle θ3 is larger than the fourth angle θ4 (or that the third angle θ3 is obtuse), the shader may determine that the third normal vector 312a (e.g., the vector associated with the third angle θ3) is directed outwardly away from the content item 300.

The shader may determine a fifth offset vertex 314a by determining a point on the third normal vector 312a that is offset from the first vertex 302a by a distance d3. In some examples, the distance d3 may correspond to one or more dimensions of the content item 300. For example, the distance d3 may be equal to a length or a height of the content item 300. In some examples, the distance d3 may be a function of (e.g., an equation based on) or proportionate to (e.g., 0-100% of) one or more dimensions of the content item 300. The shader may perform a similar process for each of the second bi-tangent vector 306b, the third bi-tangent vector 306c, and the fourth bi-tangent vector 306d, as shown in FIG. 3B, to determine a sixth offset vertex 314b, a seventh offset vertex 314c, and an eighth offset vertex 314d, respectively. In some examples, the distance d3 may be substantially equal to the distance d2, so that the offset vertices are substantially equidistant from the content item 300, which may assist in the appearance of a transitional effect with a constant thickness surrounding the content item 300.

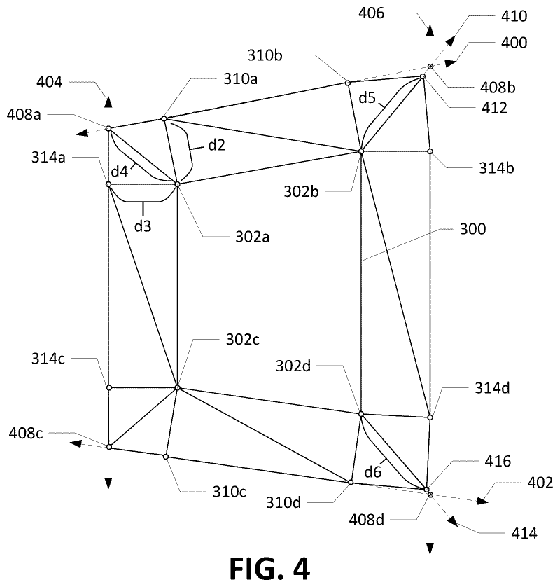

The above described methodology sets forth an initial framework for determining the mesh. In some examples, the determined offset vertices (e.g., the first offset vertex 310a, the second offset vertex 310b, the third offset vertex 310c, the fourth offset vertex 310d, the fifth offset vertex 314a, the sixth offset vertex 314b, the seventh offset vertex 314c, and the eighth offset vertex 314d) may be connected (e.g., each connected to the nearest offset vertices) to complete the mesh. In some examples, the mesh may be further developed as described with reference to FIG. 4. FIG. 4 illustrates the content item 300 with the first vertex 302a, the second vertex 302b, the third vertex 302c, the fourth vertex 302d, the first offset vertex 310a, the second offset vertex 310b, the third offset vertex 310c, the fourth offset vertex 310d, the fifth offset vertex 314a, the sixth offset vertex 314b, the seventh offset vertex 314c, and the eighth offset vertex 314d. In some examples, the shader further determines one or more offset corner vertices to assist in the appearance of a constant transitional effect surrounding the content item 300.

The shader may determine a first exterior vector 400, which may pass through both the first offset vertex 310a and the second offset vertex 310b, and may be parallel to the top side of the content item 300. Similarly, the shader may determine a second exterior vector 402, which may pass through both the third offset vertex 310c and the fourth offset vertex 310d, and may be parallel to the bottom side of the content item 300. In some examples, the shader may determine a third exterior vector 404, which may pass through both the fifth offset vertex 314a and the seventh offset vertex 314c, and may be parallel to the left side of the content item 300. In some examples, the shader may determine a fourth exterior vector 406, which may pass through both the sixth offset vertex 314b and the eighth offset vertex 314d, and may be parallel to the right side of the content item 300.

Based on the first exterior vector 400, the second exterior vector 402, the third exterior vector 404, and the fourth exterior vector 406, the shader may determine a number of points of intersections. For example, the shader may determine a first point of intersection 408a based on the first exterior vector 400 intersecting with the third exterior vector 404. The shader may determine a second point of intersection 408b based on the first exterior vector 400 intersecting with the fourth exterior vector 406. The shader may determine a third point of intersection 408c based on the second exterior vector 402 intersecting with the third exterior vector 404. the shader may determine a fourth point of intersection 408d based on the second exterior vector 402 intersecting with the fourth exterior vector 406.

In some examples, upon determining the first point of intersection 408a, the second point of intersection 408b, the third point of intersection 408c, and the fourth point of intersection 408d, the shader may connect respective vertices and points of intersections determined as described herein into various triangles, as illustrated in FIG. 4. Such triangles may assist in rendering the transitional effects and may assist in adjusting corners of the mesh as further described below.

In some examples, the shader may determine that the first point of intersection 408a, the second point of intersection 408b, the third point of intersection 408c, and the fourth point of intersection 408d should be the corners of the mesh. However, in some examples, the points of intersection may expand outwardly greater than the distance d2 or the distance d3, such that the corners of the mesh would not be substantially equidistant from the content item 300 if such points of intersection were selected to be the corners of the mesh. For example, the first point of intersection 408a may be a distance d4 away from the first vertex 302a. In some examples, the distance d4 may be larger than both the distance d2 and the distance d3. In some examples, the distance d4 may be larger than distance d2 or distance d3 by a threshold amount. In some examples, the shader may accept, as mesh corners, points of intersection having a distance from a vertex of the content item 300 larger than either distance d2 or distance d3 if the additional distance is less than or equal to the threshold amount (e.g., 15%). In some examples, the shader may accept, as mesh corners, points of intersection having a distance from a vertex of the content item 300 no larger than a distance of a hypotenuse of a triangle formed with a first leg the length of distance d2 and a second leg the length of distance d3 (e.g., the square root of the sum of the distance d2 squared and the distance d3 squared: \sqrt{(d2)²+(d3)²}). Accordingly, in the illustrated example of FIG. 4, the shader may determine that the first point of intersection 408a and the third point of intersection 408c should be corners of the mesh. However, the shader may determine that the second point of intersection 408b and the fourth point of intersection 408d extend beyond either the distance d2 or the distance d3 by at least the threshold amount and should not be corners of the mesh. In some examples, such extension may be caused by distortion of the content item when rotated in three-dimensional space and displayed in two dimensions.

To avoid distortion to the transitional effect when a content item is distorted, the shader may adjust the corners of the mesh to other vertices besides the determined points of intersection discussed above. In the illustrated example of FIG. 4, the shader may determine a first angular vector 410 starting start at the second vertex 302b and extending outwardly towards the second point of intersection 408b. The shader may determine a ninth offset vertex 412 by determining a point on the first angular vector 410 that is offset from the second vertex 302b by a distance d5. In some examples, the shader may determine the distance d5 to be equal to, or less than, either the combination of the threshold amount and the distance d2 or the combination of the threshold amount and the distance d3 (e.g., d5≤d2+threshold amount; or d5≤d3+threshold amount). In some examples, the shader may determine the distance d5 to be a function of distance d2 and/or distance d3. In some examples, the shader may determine the distance d5 to be equal to a length of a hypotenuse formed by a first leg having a length of distance d2 and a second leg having a length of distance d3 (e.g., the square root of the sum of the distance d2 squared and the distance d3 squared: d5=\sqrt{(d2)²+(d3)²}). In some examples, the shader may determine the distance d5 to be equal to the distance d4.

Similarly, the shader may determine a second angular vector 414 starting at the fourth vertex 302d and extending outwardly towards the fourth point of intersection 408d. The shader may determine a tenth offset vertex 416 by determining a point on the second angular vector 414 that is offset from the fourth vertex 302d by a distance d6. In some examples, the shader may determine the distance d6 to be equal to, or less than, either the combination of the threshold amount and the distance d2 or the combination of the threshold amount and the distance d3 (e.g., d6≤d2+threshold amount; or d6≤d3+threshold amount). In some examples, the shader may determine the distance d6 to be a function of distance d2 and/or distance d3. In some examples, the shader may determine the distance d6 to be equal to the length of the hypotenuse formed by a first leg having a length of distance d2 and a second leg having a length of distance d3 (e.g., the square root of the sum of the distance d2 squared and the distance d3 squared: d6=\sqrt{(d2)²+(d3)²}). In some examples, the shader may determine the distance d6 to be equal to the distance d4. In some examples, the shader may determine the distance d6 to be equal to the distance d5.

Based on the above methodology, the shader may determine a number of offset vertices (the first offset vertex 310a, the second offset vertex 310b, the third offset vertex 310c, the fourth offset vertex 310d, the fifth offset vertex 314a, the sixth offset vertex 314b, the seventh offset vertex 314c, the eighth offset vertex 314d, the ninth offset vertex 412, and tenth offset vertex 416; the first point of intersection 408a and the third point of intersection 408c) that are substantially equidistant from the vertices of the content item 300 (the first vertex 302a, the second vertex 302b, the third vertex 302c, and the fourth vertex 302d).

Upon determining all of the vertices of the mesh (the first vertex 302a, the second vertex 302b, the third vertex 302c, and the fourth vertex 302d; the first offset vertex 310a, the second offset vertex 310b, the third offset vertex 310c, the fourth offset vertex 310d, the fifth offset vertex 314a, the sixth offset vertex 314b, the seventh offset vertex 314c, the eighth offset vertex 314d, the ninth offset vertex 412, and tenth offset vertex 416; the first point of intersection 408a and the third point of intersection 408c), the shader may connect the offset vertices (the first offset vertex 310a, the second offset vertex 310b, the third offset vertex 310c, the fourth offset vertex 310d, the fifth offset vertex 314a, the sixth offset vertex 314b, the seventh offset vertex 314c, the eighth offset vertex 314d, the ninth offset vertex 412, and tenth offset vertex 416; the first point of intersection 408a and the third point of intersection 408c), if not already connected, to form a boundary. In some examples, the shader may apply the transitional (e.g., gradually transparent) effect described above within an area formed between the boundary and the vertices of the content item 300 (the first vertex 302a, the second vertex 302b, the third vertex 302c, and the fourth vertex 302d).

In some examples, the transitional effect may differ at the corners of the mesh in order to achieve a substantially constant thickness around the content item 300 as described above. For example, the transitional effect may be changed by a factor proportional to the orthogonality of the tangent vector (e.g., first tangent vector 304a) and bi-tangent vector (e.g., first bi-tangent vector 306a) of a corresponding vertex (e.g., first vertex 302a). In some examples, the transitional effect may be increased or decreased depending on the angle between the tangent vector and the bi-tangent vector (e.g., between zero and ninety degrees).

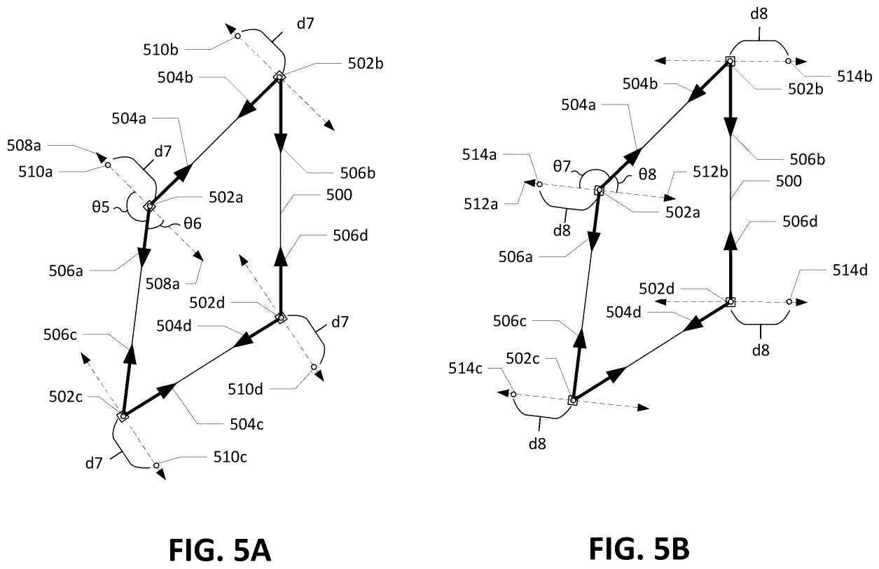

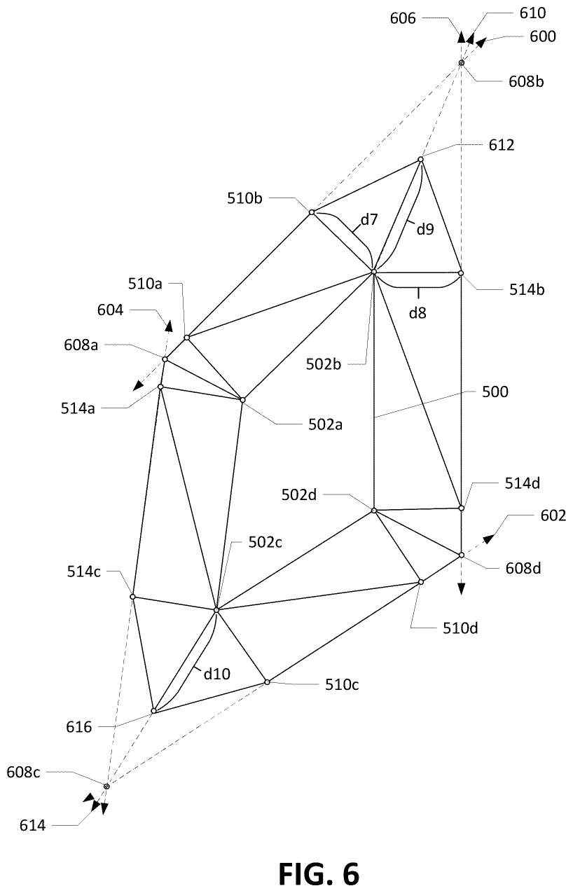

FIGS. 5A-6 illustrate another example to further explain the above described methodology. In some examples, the dimensions of a content item may become exceedingly skewed as a result of a substantial perspective change relating to the content item. For example, in the illustrated example of FIG. 5A, the content item 500 (which may have been rectangular when viewed head-on) may be viewed from a position almost directly below and to the right of the content item 500 in three-dimensional space (making it have a parallelogram shape). As content items are viewed from different perspectives, the shape of the content item may change. In some examples, the shape of the transitional effect applied to the content item may change as well. However, in some examples, the transitional effect may maintain a constant size with respect to the display on which the transitional effect is presented. Accordingly, in some examples, the shape of the content item may get smaller (e.g., due to perspective changes, zooming in/out, etc.), but the transitional effect may maintains its size (e.g., the thickness of the transitional effect surrounding the content item). Alternatively, the content item 500 may be merely have a parallelogram shape.

While the methodology for generating a mesh for the content item 500 of FIGS. 5A-6 is similar to the methodology for generating the mesh for the content item 300 of FIGS. 3A-4, the variations in the shape of the content item 500 may better illustrate the adjustments of the corners of the mesh described above.

To determine the mesh of the content item 500, the shader (e.g., shader 922 of FIG. 9) may first determine a first set of vertices. In some examples, the first set of vertices may include a first vertex 502a, a second vertex 502b, a third vertex 502c, and a fourth vertex 502d. In some examples, the first vertex 502a, the second vertex 502b, the third vertex 502c, and the fourth vertex 502d may be associated with corners of the content item 500. In some examples, the first vertex 502a, the second vertex 502b, the third vertex 502c, and the fourth vertex 502d may be associated with corners of the smallest quadrilateral that fully encloses the content item 500.

For each of the first vertex 502a, the second vertex 502b, the third vertex 502c, and the fourth vertex 502d, the shader may determine one or more tangent vectors along one side of the content item 500 and one or more bi-tangent vectors along another side of the content item 500. For example, the shader may determine a first tangent vector 504a starting at the first vertex 502a and extending along a top side of the content item 500. In some examples, the shader may determine a first bi-tangent vector 506a starting at the first vertex 502a and extending along a left side of the content item 500. In some examples, the shader may determine a second tangent vector 504b starting at the second vertex 502b and extending along the top side of the content item 500. In some examples, the shader may determine a second bi-tangent vector 506b starting at the second vertex 502b and extending along a right side of the content item 500. In some examples, the shader may determine a third tangent vector 504c starting at the third vertex 502c and extending along the bottom side of the content item 500. In some examples, the shader may determine a third bi-tangent vector 506c starting at the third vertex 502c and extending along the left side of the content item 500. In some examples, the shader may determine a fourth tangent vector 504d starting at the fourth vertex 502d and extending along the bottom side of the content item 500. In some examples, the shader may determine a fourth bi-tangent vector 506d starting at the fourth vertex 502d and extending along the right side of the content item 500.

As illustrated in FIG. 5A, the first tangent vector 504a and the second tangent vector 504b; the third tangent vector 504c and the fourth tangent vector 504d; the first bi-tangent vector 506a and the third bi-tangent vector 506c; and the second bi-tangent vector 506b and the fourth bi-tangent vector 506d may be directed towards each other and towards a center line of the content item 500.

For each tangent vector, the shader may determine one or more associated normal vectors. For example, for the first tangent vector 504a, the shader may determine a first normal vector 508a and a second normal vector 508b. In some examples, the first normal vector 508a and the second normal vector 508b may be within the same plane as the content item 500. In some examples, the first normal vector 508a may be a vector rotated 90 degrees counterclockwise from the first tangent vector 504a around the first vertex 502a (or away from a center of the content item). In some examples, the second normal vector 508b may be a vector rotated 90 degrees clockwise from the first tangent vector 504a around the first vertex 502a (or towards a center of the content item).

In some examples, the shader is configured to determine which normal vector of the first normal vector 508a and the second normal vector 508b is directed outwardly away from the content item 500. In some examples, the shader may determine which normal vector of the first normal vector 508a and the second normal vector 508b is furthest from an adjacent bi-tangent vector (e.g., an adjacent bi-tangent vector that shares a vertex with the tangent vector upon which the normal vectors are based). For example, the shader may determine which normal vector of the first normal vector 508a and the second normal vector 508b is furthest from the first bi-tangent vector 506a (which starts from the first vertex 502a as does the first tangent vector 504a upon with the first normal vector 508a and the second normal vector 508b are based). In some examples, the shader may determine a seventh angle θ5 from the first normal vector 508a to the first bi-tangent vector 506a. In some examples, the shader may determine an eighth angle θ6 from the second normal vector 508b to the first bi-tangent vector 506a. In some examples, the shader may compare the seventh angle θ5 to the eighth angle θ6 to determine which angle is larger. In some examples, the shader may determine which of the seventh angle θ5 or the eighth angle θ6 is an obtuse angle (e.g., greater than 90 degrees). Based on determining which angle is larger or is the obtuse angle, the shader may determine that the corresponding normal vector associated with the larger angle is directed outwardly away from the content item. In the illustrated example of FIG. 5A, the seventh angle θ5 is larger than the eighth angle θ6 (and the seventh angle θ5 is an obtuse angle while the eighth angle θ6 is an acute angle). Upon determining that the seventh angle θ5 is larger than the eighth angle θ6 (or that seventh angle θ5 is obtuse), the shader may determine that the first normal vector 508a (e.g., the vector associated with the seventh angle θ5) is directed outwardly away from the content item 500.

The shader may determine a first offset vertex 510a by determining a point on the first normal vector 508a that is offset from the first vertex 502a by a distance d7. In some examples, the distance d7 may correspond to one or more dimensions of the content item 500. For example, the distance d7 may be equal to a length or a height of the content item 500. In some examples, the distance d7 may be a function of (e.g., an equation based on) or proportionate to (e.g., 0-100% of) one or more dimensions of the content item 500. The shader may perform a similar process for each of the second tangent vector 504b, the third tangent vector 504c, and the fourth tangent vector 504d, as shown in FIG. 5A, to determine a second offset vertex 510b, a third offset vertex 510c, and a fourth offset vertex 510d, respectively.

A similar methodology may be performed by the shader with respect to the bi-tangent vectors. As similarly described above with reference to FIG. 5A, the shader may determine, for each bi-tangent vector, one or more associated normal vectors as shown and described with reference to FIG. 5B. For example, for the first bi-tangent vector 506a, the shader may determine a third normal vector 512a and a fourth normal vector 512b. In some examples, the third normal vector 512a and the fourth normal vector 512b may be within the same plane as the content item 500. In some examples, the third normal vector 512a may be a vector rotated 90 degrees clockwise from the first bi-tangent vector 506a around the first vertex 502a (or away from a center of the content item). In some examples, the fourth normal vector 512b may be a vector rotated 90 degrees counter clockwise from the first bi-tangent vector 506a around the first vertex 502a (or towards a center of the content item).

In some examples, the shader is configured to determine which normal vector of the third normal vector 512a and the fourth normal vector 512b is directed outwardly away from the content item 500. In some examples, the shader may determine which normal vector of the third normal vector 512a and the fourth normal vector 512b is furthest from an adjacent tangent vector (e.g., an adjacent tangent vector that shares a vertex with the bi-tangent vector upon which the normal vectors are based). For example, the shader may determine which normal vector of the third normal vector 512a and the fourth normal vector 512b is furthest from the first tangent vector 504a (which starts from the first vertex 502a as does the first bi-tangent vector 506a upon with the third normal vector 512a and the fourth normal vector 512b are based). In some examples, the shader may determine a ninth angle θ7 from the third normal vector 512a to the first tangent vector 504a. In some examples, the shader may determine a tenth angle θ8 from the fourth normal vector 512b to the first tangent vector 504a. In some examples, the shader may compare the ninth angle θ7 to the tenth angle θ8 to determine which angle is larger. In some examples, the shader may determine which of the ninth angle θ7 or the tenth angle θ8 is an obtuse angle (e.g., greater than 90 degrees). Based on determining which angle is larger or is the obtuse angle, the shader may determine that the corresponding normal vector associated with the larger angle is directed outwardly away from the content item. In the illustrated example of FIG. 5B, the ninth angle θ7 is larger than the tenth angle θ8 (and the ninth angle θ7 is an obtuse angle while the tenth angle θ8 is an acute angle). Upon determining that the ninth angle θ7 is larger than the tenth angle θ8 (or that the ninth angle θ7 is obtuse), the shader may determine that the third normal vector 512a (e.g., the vector associated with the ninth angle θ7) is directed outwardly away from the content item 500.

The shader may determine a fifth offset vertex 514a by determining a point on the third normal vector 512a that is offset from the first vertex 502a by a distance d8. In some examples, the distance d8 may correspond to one or more dimensions of the content item 500. For example, the distance d8 may be equal to a length or a height of the content item 500. In some examples, the distance d8 may be a function of (e.g., an equation based on) or proportionate to (e.g., 0-100% of) one or more dimensions of the content item 500. The shader may perform a similar process for each of the second bi-tangent vector 506b, the third bi-tangent vector 506c, and the fourth bi-tangent vector 506d, as shown in FIG. 5B, to determine a sixth offset vertex 514b, a seventh offset vertex 514c, and an eighth offset vertex 514d, respectively. In some examples, the distance d8 may be substantially equal to the distance d7, so that the offset vertices are substantially equidistant from the content item 500, which may assist in the appearance of a transitional effect with a constant thickness surrounding the content item 500.

The above described methodology sets forth an initial framework for determining the mesh. In some examples, the determined offset vertices (e.g., the first offset vertex 510a, the second offset vertex 510b, the third offset vertex 510c, the fourth offset vertex 510d, the fifth offset vertex 514a, the sixth offset vertex 514b, the seventh offset vertex 514c, and the eighth offset vertex 514d) may be connected (e.g., each connected to the nearest offset vertices) to complete the mesh. In some examples, the mesh may be further developed as described with reference to FIG. 6. FIG. 6 illustrates the content item 500 with the first vertex 502a, the second vertex 502b, the third vertex 502c, the fourth vertex 502d, the first offset vertex 510a, the second offset vertex 510b, the third offset vertex 510c, the fourth offset vertex 510d, the fifth offset vertex 514a, the sixth offset vertex 514b, the seventh offset vertex 514c, and the eighth offset vertex 514d. In some examples, the shader further determines one or more offset corner vertices to assist in the appearance of a constant transitional effect surrounding the content item 500.

The shader may determine a first exterior vector 600, which may pass through both the first offset vertex 510a and the second offset vertex 510b, and may be parallel to the top side of the content item 500. Similarly, the shader may determine a second exterior vector 602, which may pass through both the third offset vertex 510c and the fourth offset vertex 510d, and may be parallel to the bottom side of the content item 500. In some examples, the shader may determine a third exterior vector 604, which may pass through both the fifth offset vertex 514a and the seventh offset vertex 514c, and may be parallel to the left side of the content item 500. In some examples, the shader may determine a fourth exterior vector 606, which may pass through both the sixth offset vertex 514b and the eighth offset vertex 514d, and may be parallel to the right side of the content item 500.

Based on the first exterior vector 600, the second exterior vector 602, the third exterior vector 604, and the fourth exterior vector 606, the shader may determine a number of points of intersections. For example, the shader may determine a first point of intersection 608a based on the first exterior vector 600 intersecting with the third exterior vector 604. The shader may determine a second point of intersection 608b based on the first exterior vector 600 intersecting with the fourth exterior vector 606. The shader may determine a third point of intersection 608c based on the second exterior vector 602 intersecting with the third exterior vector 604. the shader may determine a fourth point of intersection 608d based on the second exterior vector 602 intersecting with the fourth exterior vector 606.

In some examples, upon determining the first point of intersection 608a, the second point of intersection 608b, the third point of intersection 608c, and the fourth point of intersection 608d, the shader may connect respective vertices and points of intersections determined as described herein into various triangles, as illustrated in FIG. 6. Such triangles may assist in rendering the transitional effects and may assist in adjusting corners of the mesh as further described below.

In some examples, the shader may determine that the first point of intersection 608a, the second point of intersection 608b, the third point of intersection 608c, and the fourth point of intersection 608d should be the corners of the mesh. However, in some examples, the points of intersection may expand outwardly greater than the distance d7 or the distance d8, such that the corners of the mesh would not be substantially equidistant from the content item 500 if such points of intersection were selected to be the corners of the mesh. For example, the second point of intersection 608b may be drastically farther from the second vertex 502b than either distance d7 or distance d8, as illustrated in FIG. 6. Likewise, the third point of intersection 608c may be drastically farther from the third vertex 502c than either distance d7 or distance d8.

Accordingly, in the illustrated example of FIG. 6, the shader may determine that the first point of intersection 608a and the fourth point of intersection 608d should be corners of the mesh. However, the shader may determine that the second point of intersection 608b and the third point of intersection 608c extend beyond either the distance d7 or the distance d8 by at least a threshold amount, and thus should not be corners of the mesh.

To avoid distortion to the transitional effect (e.g., elongation to one or more corners) when a content item is distorted, the shader may adjust the corners of the mesh to other vertices besides the determined points of intersection discussed above. In the illustrated example of FIG. 6, the shader may determine a third angular vector 610 starting start at the second vertex 502b and extending outwardly towards the second point of intersection 608b. The shader may determine a ninth offset vertex 612 by determining a point on the third angular vector 610 that is offset from the second vertex 602b by a distance d9. In some examples, the shader may determine the distance d9 to be equal to, or less than, either the combination of the threshold amount and the distance d7 or the combination of the threshold amount and the distance d8 (e.g., d9≤d7+threshold amount; or d9≤d8+threshold amount). In some examples, the shader may determine the distance d9 to be a function of distance d7 and/or distance d8. In some examples, the shader may determine the distance d9 to be equal to a length of a hypotenuse formed by a first leg having a length of distance d7 and a second leg having a length of distance d8 (e.g., the square root of the sum of the distance d7 squared and the distance d8 squared: d9=\sqrt{(d7)²+(d8)²}). As illustrated in FIG. 6, the distance d9 is significantly shorter than that distance from the second vertex 502b to the second point of intersection 608b. Indeed, the ninth offset vertex 612 being the distance d9 away from the second vertex 502b ensures that the area between the offset vertices and the vertices of the content item 500 is substantially constant around the entirety of the content item 500 (despite distortion of the content item 500 based on the particular perspective).

Similarly, the shader may determine a fourth angular vector 614 starting at the third vertex 502c and extending outwardly towards the third point of intersection 608c. The shader may determine a tenth offset vertex 616 by determining a point on the fourth angular vector 614 that is offset from the third vertex 502c by a distance d10. In some examples, the shader may determine the distance d10 to be equal to, or less than, either the combination of the threshold amount and the distance d7 or the combination of the threshold amount and the distance d8 (e.g., d10≤d7+threshold amount; or d10≤d8+threshold amount). In some examples, the shader may determine the distance d10 to be a function of distance d7 and/or distance d8. In some examples, the shader may determine the distance d10 to be equal to the length of the hypotenuse formed by a first leg having a length of distance d7 and a second leg having a length of distance d8 (e.g., the square root of the sum of the distance d7 squared and the distance d8 squared: d10=\sqrt{(d7)²+(d8)²}). In some examples, the shader may determine the distance d10 to be equal to the distance d9.

Based on the above methodology, the shader may determine a number of offset vertices (the first offset vertex 510a, the second offset vertex 510b, the third offset vertex 510c, the fourth offset vertex 510d the fifth offset vertex 514a, the sixth offset vertex 514b, the seventh offset vertex 514c, the eighth offset vertex 514d, the ninth offset vertex 612, and tenth offset vertex 616; the first point of intersection 608a and the fourth point of intersection 608d) that are substantially equidistant from the vertices of the content item 500 (the first vertex 502a, the second vertex 502b, the third vertex 502c, and the fourth vertex 502d).

Upon determining all of the vertices of the mesh (the first vertex 502a, the second vertex 502b, the third vertex 502c, and the fourth vertex 502d; the first offset vertex 510a, the second offset vertex 510b, the third offset vertex 510c, the fourth offset vertex 510d the fifth offset vertex 514a, the sixth offset vertex 514b, the seventh offset vertex 514c, the eighth offset vertex 514d, the ninth offset vertex 612, and tenth offset vertex 616; the first point of intersection 608a and the fourth point of intersection 608d), the shader may connect the offset vertices (the first offset vertex 510a, the second offset vertex 510b, the third offset vertex 510c, the fourth offset vertex 510d the fifth offset vertex 514a, the sixth offset vertex 514b, the seventh offset vertex 514c, the eighth offset vertex 514d, the ninth offset vertex 612, and tenth offset vertex 616; the first point of intersection 608a and the fourth point of intersection 608d), if not already connected, to form a boundary. In some examples, the shader may apply the gradually transparent effect described above within an area formed between boundary and the vertices of the content item 500 (the first vertex 502a, the second vertex 502b, the third vertex 502c, and the fourth vertex 502d).

In some examples, the transitional effect may differ at the corners of the mesh in order to achieve a substantially constant thickness around the content item 500 as described above. For example, the transitional effect may be changed by a factor proportional to the orthogonality of the tangent vector (e.g., first tangent vector 504a) and bi-tangent vector (e.g., first bi-tangent vector 506a) of a corresponding vertex (e.g., first vertex 502a). In some examples, the transitional effect may be increased or decreased depending on the angle between the tangent vector and the bi-tangent vector (e.g., between zero and ninety degrees).

In the illustrated examples of FIGS. 3A-6, the content items 300, 500 were planar content items. In some examples, the shader may perform another methodology for non-planar (e.g., three-dimensional) content items, as further described below with reference to FIG. 7. In some examples, the methodology described with reference to FIG. 7 may also be applied to planar content as well.

As illustrated in FIG. 7, a content item 700 is shown. In some examples, the content item 700 may ellipsoidal. In some examples, the content item 700 may be three-dimensional. In some examples, the content item 700 may be approximated as a planar ellipsoid. In some examples, the shader may determine a first set of vertices 702 around the edge of the content item 700. In some examples, the shader may determine the first set of vertices 702 around the edge of the approximated ellipsoid (e.g., the smallest ellipsoid that fully encloses the content item 700). In some examples, the vertices 702 may be distanced from a center point 704 of the content item 700. In some examples, the vertices 702 may have a same distance from the center point 704 (e.g., where the content item is a perfect circle or sphere or a regular polygon). In some examples, the vertices 702 may be distanced from the center point 704 at various distances (e.g., every other shape). In some examples, the content item 700 may have a semi-minor axis 706 and a semi-major axis 708. In some examples, the semi-minor axis 706 may have a length/distance d11. In some examples, the semi-major axis 708 may have a length/distance d12. In some examples, the distance from the center point 704 to a respective vertex may be a function of the semi-major axis 708 and the semi-minor axis 706. For example, the distance may be the length of a radius (r(θ)) of an ellipsoid defined according to equation 1.

$$r ( θ ) = \frac{a b}{\sqrt{{( b cos θ )}^{2} + {( a sin θ )}^{2}}} \qquad Equation 1$$

where a may be the length of the semi-major axis 708, b may be the length of the semi-minor axis 706, and θ may be the angle between the radius and the major (horizontal) axis).

Based on the first set of vertices 702 and the respective distances between the first set of vertices 702 and the center point 704, the shader may determine a second set of vertices 710 offset from the first set of vertices by a distance d13. In some examples, the distance d13 may be equal to a length (e.g., two times the distance d12) or a height (e.g., two times the distance d11) of the content item 700. In some examples, the distance d13 may be a function of (e.g., an equation based on) or proportionate to (e.g., 0-100% of) the length or height of the content item. In some examples, the distance d13 may be equal to either distance d11 or distance d12. In some examples, the distance d13 may be the smallest of either distance d11 or distance d12 (e.g., min (distance d11, distance d12)). In some examples, the distance d13 may be the largest of either distance d11 or distance d12 (e.g., max (distance d11, distance d12)). In some examples, the distance d13 may be the average between the distance d11 and the distance d12 (e.g., avg(distance d11, distance d12)). In some examples, the distance d13 may be a predetermined amount of pixels in screen space. In some examples, the distance d13 may be fixed. In some examples, the distance d13 may be configurable by a user.

Based on the second set of vertices 710, the shader may determine a boundary 712. The boundary 712 may connect each of the second set of vertices 710 together via line segments, arcs, or a combination thereof. In some examples, the second set of vertices 710 and the first set of vertices 702 may be connected together (e.g., with geometric triangles) to create a mesh for the content item 700. In some examples, the shader may apply the transitional (e.g., gradually transparent) effect described above within an area formed between the boundary 712 and the first set of vertices 702. In such a way, the shader may create a transitional effect with a constant thickness around the content item 700 as described above. In some examples, the shader may rotate the mesh (e.g., and thus the translational effect) in response to changes of perspective by a user or content item rotation. For example, the shader may rotate the mesh such that it always faces the user as the user moves about in 3D space or as the user rotates the content item.

In some examples, a content item may have one or more other content items within the edges of the content item. For example, an application may have a number of content items therewithin. In some examples, each content item (e.g., including those that may be within a larger content item such as an application) may be associated with its own mesh as described herein. In some examples, every content item within a larger content item may be associated with a transitional effect when that larger content item is subject to a user's current focus and/or selection. In some such examples, overlapping content items within a larger content item may have their transitional effects stacked or otherwise added together (e.g., increasing the size or thickness of the transitional effect adjacent the overlapping portions). In some examples, meshes associated with content items within a larger content item may be discarded or otherwise merged. For example, any meshes that are determined to be completely enclosed within another mesh and related to a same content item may be discarded. In some such examples, transitional effect stacking may be minimized.

In some examples, the shader may conduct pre-processing to increase efficiencies with rendering content items and associated transitional effects as disclosed herein. In some examples, the shader may perform a pre-pass on a first content item to determine the edges of the first content item and prevent rendering of any other content that would otherwise be rendered within the coordinates/pixels associated with the content item on a display screen. In some examples, this pre-pass may preclude processing corresponding to content items that may have one or more portions behind, in-front of, or otherwise conflicting with the content item. In some examples, the shader may use an occluder associated with the content item to determine whether one or more other content items have portions behind, in-front of, or otherwise conflicting with the content item, and prevent any processing associated with those portions to occur early within the graphics pipeline.

In some examples, content items may comprise metadata that may inform the shader how to and/or whether to apply a transitional effect. For example, the metadata may comprise a proxy mesh associated with the content item that should be used instead of an associated occluder or the edges of the content item itself. In some examples, the proxy mesh may smaller than the content item in order to minimize the transitional effect associated with a particular content item. In some examples, the proxy mesh may be larger than the content item in order to maximize the transitional effect associated with a particular content item. In some examples, the metadata may comprise an indicator that no transitional effect should be applied to a particular content item. For example, content items relating to a device interface or heads-up-display (HUD) may comprise metadata indicating no transitional effect should be applied. In some examples, the metadata may further including data indicating to the shader that such content items should never be overlapped, occluded, intersected, etc. (e.g., metadata indicating such content items should be “always on top”).

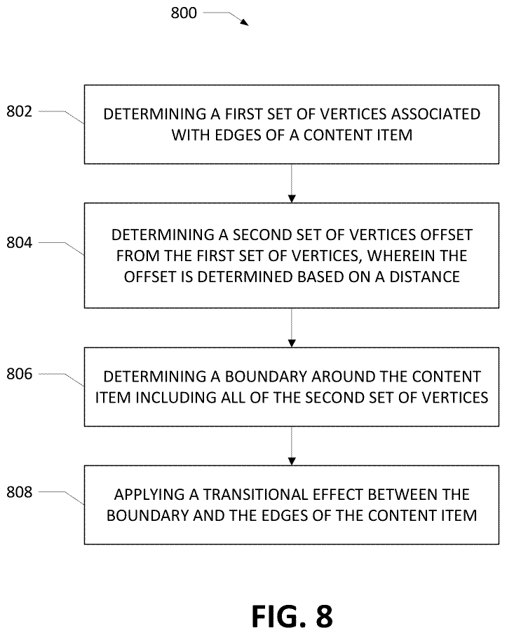

An example method 800 for generating a mesh and applying a transitional effect as described is represented by the flowchart illustrated in FIG. 8. In some examples, the method 800 may be performed by one or more processors. In some examples, the method 800 may be performed by a shader (e.g., shader 922). The method 800 may start at block 802, where the processor or shader may determine a first set of vertices associated with edges of a content item. In some examples, the first set of vertices are determined based on an already existing occluder mesh associated with the content item. In some examples, the first set of vertices may be corners of a polygonal content item. In some examples, the first set of vertices may be a plurality of vertices surrounding the content item. At block 804, the processor or shader may determine a second set of vertices offset from the first set of vertices, wherein the offset is determined based on a distance. In some examples, the second set of vertices may be offset from the first set of vertices by a constant distance. In some examples, the second set of vertices may be similar to the first set of vertices, but extended outwardly by the distance. In some examples, the second set of vertices may be offset by one or more distances. In some examples, the second set of vertices may be substantially equidistant from the first set of vertices (e.g., within a threshold variance). In some examples, the distance(s) may be determined based on one or more equations. In some examples, the distance(s) may be a function of one or more properties of (and/or metadata associated with) the content item. At block 806, the processor or shader may determine a boundary around the content item including all of the second set of vertices. At block 808, the processor or shader may apply a transitional effect (e.g., a gradually decreasing transparent border) between the boundary and the edges of the content item. In some examples, the transitional effect may be a transparent gradient that gradually decreases in transparency as distance from the content item increases. In some examples, the transitional effect may be a transparent gradient that gradually increases in transparency as distance towards the content item increases. In some examples, the transitional effect may be based on a Bezier curve. In some examples, the processor or shader may apply the transitional effect in response to a conflict occurrence involving the content item and at least one other content item. In some examples, the processor or shader may cease application of the transitional effect upon resolution of the conflict occurrence (e.g., when there is no longer a conflict with another content item). In some examples, the method 800 may be repeated (e.g., per frame, every time a perspective change occurs with respect to the content item and a user's viewpoint, or a combination thereof).

FIG. 9 is a block diagram of electronic device 900. Device 900 illustrates an exemplary device configuration for electronic device 100. While certain specific features are illustrated, those skilled in the art will appreciate from the present disclosure that various other features have not been illustrated for the sake of brevity, and so as not to obscure more pertinent aspects of the examples disclosed herein. To that end, as a non-limiting example, in some examples the device 900 includes one or more processors 902 (e.g., microprocessors, ASICs, FPGAs, GPUS, CPUs, processing cores, and/or the like), one or more input/output (I/O) devices and sensors 904, one or more communication interfaces 906 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 908, one or more output device(s) 910, one or more interior and/or exterior facing image sensor systems 912, a memory 914, and one or more communication buses 916 for interconnecting these and various other components.

In some examples, the one or more communication buses 916 include circuitry that interconnects and controls communications between system components. In some examples, the one or more I/O devices and sensors 904 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some examples, the one or more output device(s) 910 include one or more displays configured to present a view of a 3D environment to the user. In some examples, the one or more output device(s) 910 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some examples, the one or more displays correspond to diffractive, reflective, polarized, holographic, etc. waveguide displays. In some examples, the device 900 includes a display for each eye of the user.

In some examples, the one or more output device(s) 910 include one or more audio producing devices. In some examples, the one or more output device(s) 910 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 910 may additionally or alternatively be configured to generate haptics.

In some examples, the one or more image sensor systems 912 are configured to obtain image data that corresponds to at least a portion of a physical environment. For example, the one or more image sensor systems 912 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various examples, the one or more image sensor systems 912 further include illumination sources that emit light, such as a flash. In various examples, the one or more image sensor systems 912 further include an on-camera image signal processor (ISP) configured to execute a plurality of processing operations on the image data.

The memory 914 includes high-speed random-access memory, such as DRAM, SRAM, DDR RAM, or other random-access solid-state memory devices. In some examples, the memory 914 includes non-volatile memory, such as one or more magnetic disk storage devices, optical disk storage devices, flash memory devices, or other non-volatile solid-state storage devices. The memory 914 optionally includes one or more storage devices remotely located from the one or more processors 902. The memory 914 comprises a non-transitory computer readable storage medium.

In some examples, the memory 914 or the non-transitory computer readable storage medium of the memory 914 stores an optional operating system 918 and one or more instruction set(s) 920. The operating system 918 includes procedures for handling various basic system services and for performing hardware dependent tasks. In some examples, the instruction set(s) 920 include executable software defined by binary information stored in the form of electrical charge. In some examples, the instruction set(s) 920 are software that is executable by the one or more processors 902 to carry out one or more of the techniques described herein. The instruction set(s) 920 may include a shader 922 configured to, upon execution, generate one or more custom meshes for the rendering of a transitional effect, as described herein.

Although the instruction set(s) 920 are shown as residing on a single device, it should be understood that in other examples, any combination of the elements may be located in separate computing devices. Moreover, FIG. 9 is intended more as functional description of the various features which are present in a particular example as opposed to a structural schematic of the examples described herein. As recognized by those of ordinary skill in the art, items shown separately could be combined and some items could be separated. The actual number of instructions sets and how features are allocated among them may vary from one example to another and may depend in part on the particular combination of hardware, software, and/or firmware chosen for a particular example.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology may comprise determining a first set of vertices associated with edges of a content item.

Another aspect of the present technology may comprise determining a second set of vertices offset from the first set of vertices, wherein the offset is determined based on a distance.

Another aspect of the present technology may comprise determining a boundary around the content item including all of the second set of vertices.

Another aspect of the present technology may comprise applying a transitional effect between the boundary and the edges of the content item.

Another aspect of the present technology may comprise determining the distance based on a first distance from a center of the content item to a first vertex of the first set of vertices.

Another aspect of the present technology may comprise determining the distance based on a second distance from a center of the content item to a first edge of the edges of the content item.

Another aspect of the present technology may comprise determining, for each respective first vertex of the first set of vertices: a first vector starting at the respective first vertex and extending along a first side of the content item, a second vector starting at the respective first vertex and extending along a second side of the content item, a third vector that is normal to the first vector and furthest from the second vector, and a fourth vector that is normal to the second vector and furthest from the first vector.

Another aspect of the present technology may comprise determining a plurality of vertices offset the distance away from the first set of vertices and along the respective third vectors and fourth vectors.

Another aspect of the present technology may comprise determining a fifth vector extending parallel with the first side of the content item and intersecting at least one respective third vector at at least one second vertex of the second set of vertices.

Another aspect of the present technology may comprise determining a sixth vector extending parallel with the second side of the content item and intersecting at least one respective fourth vector at at least one third vertex of the second set of vertices.

Another aspect of the present technology may comprise determining a point of intersection between the fifth vector and the sixth vector.

Another aspect of the present technology may comprise selecting the point of intersection as one of the second set of vertices.

Another aspect of the present technology may comprise determining that a third distance between the point of intersection and the respective first vertex exceeds the distance by a threshold amount.

Another aspect of the present technology may comprise determining a seventh vector starting from the respective first vertex and extending to the point of intersection.

Another aspect of the present technology may comprise determining a fourth vertex offset the distance away from the respective first vertex and along the seventh vector.

Another aspect of the present technology may comprise selecting the fourth vertex as one of the second set of vertices.

Another aspect of the present technology may comprise determining a first angle between the fifth vector and the sixth vector is less than a threshold.

Another aspect of the present technology may comprise determining an eighth vector starting from the respective first vertex and extending to the point of intersection.

Another aspect of the present technology may comprise determining a point on the eighth vector where a second angle between a ninth vector starting at the point and extending towards a first vertex of the plurality of vertices and a tenth vector starting at the point and extending towards a second vertex of the plurality of vertices exceeds the threshold.

Another aspect of the present technology may comprise selecting the point as one of the second set of vertices.

Another aspect of the present technology may comprise causing portions of other content items in a vicinity of the content item to become transparent.

Another aspect of the present technology may comprise applying a gradient effect that extends outwardly from the edges of the content item towards the boundary, and causes portions of other content items in a vicinity of the content item to become transparent according to the gradient effect.

Another aspect of the present technology may comprise determining a perspective change associated with the content item.

Another aspect of the present technology may comprise discarding the first set of vertices and the boundary.

Another aspect of the present technology may comprise determining a third set of vertices associated with edges of a content item from a new perspective.

Another aspect of the present technology may comprise determining a fourth set of vertices offset from the third set of vertices, wherein the offset is determined based on the distance.

Another aspect of the present technology may comprise determining a second boundary around the content item including all of the fourth set of vertices.

Another aspect of the present technology may comprise ceasing application of the first transitional effect.

Another aspect of the present technology may comprise applying a second transitional effect between the second boundary and the edges of the content item.

Another aspect of the present technology may comprise determining the edges of the content item based on an occluder mesh associated with the content item.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method, comprising:
at a processor:
determining a first set of vertices associated with edges of a content item;
determining a second set of vertices offset from the first set of vertices, wherein the offset is determined based on a distance;
determining a boundary around the content item including all of the second set of vertices; and
applying a transitional effect between the boundary and the edges of the content item.

2. The method of claim 1, further comprising determining the distance based on a first distance from a center of the content item to a first vertex of the first set of vertices.

3. The method of claim 1, further comprising determining the distance based on a second distance from a center of the content item to a first edge of the edges of the content item.

4. The method of claim 1, wherein determining the second set of vertices comprises:
for each respective first vertex of the first set of vertices:
determining a first vector starting at the respective first vertex and extending along a first side of the content item;
determining a second vector starting at the respective first vertex and extending along a second side of the content item;
determining a third vector that is normal to the first vector and furthest from the second vector;
determining a fourth vector that is normal to the second vector and furthest from the first vector; and
determining a plurality of vertices offset the distance away from the first set of vertices and along the respective third vectors and fourth vectors.

5. The method of claim 4, wherein determining the second set of vertices further comprises:
determining a fifth vector extending parallel with the first side of the content item and intersecting at least one respective third vector at at least one second vertex of the second set of vertices;
determining a sixth vector extending parallel with the second side of the content item and intersecting at least one respective fourth vector at at least one third vertex of the second set of vertices; and
determining a point of intersection between the fifth vector and the sixth vector.

6. The method of claim 5, further comprising selecting the point of intersection as one of the second set of vertices.

7. The method of claim 5, wherein determining the second set of vertices further comprises:
determining that a third distance between the point of intersection and the respective first vertex exceeds the distance by a threshold amount;
determining a seventh vector starting from the respective first vertex and extending to the point of intersection;
determining a fourth vertex offset the distance away from the respective first vertex and along the seventh vector; and
selecting the fourth vertex as one of the second set of vertices.

8. The method of claim 5, wherein determining the second set of vertices further comprises:
determining a first angle between the fifth vector and the sixth vector is less than a threshold;
determining an eighth vector starting from the respective first vertex and extending to the point of intersection;
determining a point on the eighth vector where a second angle between a ninth vector starting at the point and extending towards a first vertex of the plurality of vertices and a tenth vector starting at the point and extending towards a second vertex of the plurality of vertices exceeds the threshold; and
selecting the point as one of the second set of vertices.

9. The method of claim 1, wherein applying the transitional effect between the boundary and the edges of the content item causes portions of other content items in a vicinity of the content item to become transparent.

10. The method of claim 1, wherein applying the transitional effect between the boundary and the edges of the content item comprises applying a gradient effect that extends outwardly from the edges of the content item towards the boundary, and causes portions of other content items in a vicinity of the content item to become transparent according to the gradient effect.

11. The method of claim 1, wherein the first set of vertices associated with the edges of the content item correspond to a first perspective of the content item, and wherein the boundary is a first boundary, the method further comprising:
determining a perspective change associated with the content item;
discarding the first set of vertices and the first boundary;
determining a third set of vertices associated with edges of a content item from a new perspective;
determining a fourth set of vertices offset from the third set of vertices, wherein the offset is determined based on the distance; and
determining a second boundary around the content item including all of the fourth set of vertices.

12. The method of claim 11, wherein the transitional effect is a first transitional effect, the method further comprising:
ceasing application of the first transitional effect; and
applying a second transitional effect between the second boundary and the edges of the content item.

13. The method of claim 1, wherein the edges of the content item are determined based on an occluder mesh associated with the content item.

14. An apparatus comprising:
one or more processors; and
memory storing instructions that, when executed by the one or more processors, cause performance of operations comprising:
determining a first set of vertices associated with edges of a content item;
determining a second set of vertices offset from the first set of vertices, wherein the offset is determined based on a distance;
determining a boundary around the content item including all of the second set of vertices; and
applying a transitional effect between the boundary and the edges of the content item.

15. The apparatus of claim 14, wherein the operations further comprise determining the distance based on a first distance from a center of the content item to a first vertex of the first set of vertices.

16. The apparatus of claim 14, wherein the operations further comprise determining the distance based on a second distance from a center of the content item to a first edge of the edges of the content item.

17. The apparatus of claim 14, wherein determining the second set of vertices comprises:
for each respective first vertex of the first set of vertices:
determining a first vector starting at the respective first vertex and extending along a first side of the content item;
determining a second vector starting at the respective first vertex and extending along a second side of the content item;
determining a third vector that is normal to the first vector and furthest from the second vector;
determining a fourth vector that is normal to the second vector and furthest from the first vector; and
determining a plurality of vertices offset the distance away from the first set of vertices and along the respective third vectors and fourth vectors.

18. The apparatus of claim 17, wherein determining the second set of vertices further comprises:
determining a fifth vector extending parallel with the first side of the content item and intersecting at least one respective third vector at at least one second vertex of the second set of vertices;
determining a sixth vector extending parallel with the second side of the content item and intersecting at least one respective fourth vector at at least one third vertex of the second set of vertices; and
determining a point of intersection between the fifth vector and the sixth vector.

19. The apparatus of claim 18, wherein the operations further comprise selecting the point of intersection as one of the second set of vertices.

20. A non-transitory computer readable storage medium storing instructions that, when executed by one or more processors, cause performance of operations comprising:
determining a first set of vertices associated with edges of a content item;
determining a second set of vertices offset from the first set of vertices, wherein the offset is determined based on a distance;
determining a boundary around the content item including all of the second set of vertices; and
applying a transitional effect between the boundary and the edges of the content item.
